(19) United States
(12) Patent Application Publication
(10) Pub. No.: US 2008/0220624 A1
(43) Pub. Date: Sep. 11, 2008

(54) METHOD AND APPARATUS FOR RESTRICTING ROTATIONAL MOMENT ABOUT A LONGITUDINAL AXIS OF SMT CONNECTORS

(75) Inventors: William L. Brodsky, Binghamton, NY (US); Mark G. Clark, Rochester, MN (US); Amanda E.E. Mikhail, Rochester, MN (US); Arvind K. Sinha, Rochester, MN (US); Scott A. Shurson, Mantorville, MN (US); Jason T. Stoll, Rochester, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/683,501

(22) Filed: Mar. 8, 2007

(51) Int. Cl. H01R 12/00

(52) U.S. Cl. 439/55

(57) ABSTRACT

Ali apparatus for supporting at least one electrical connector body, the apparatus includes a mechanical frame assembly mountable to a printed circuit board (PCB) and separable from the at least one connector body and the PCB. The frame assembly includes at least one base member for attachment to the PCB; and a plurality of rigid body members each spaced apart from one another and extending from the at least one base member or an adjacent rigid body member. The plurality of rigid body members receive a grouping of one or more connector bodies and a pair of adjacent rigid body members are configured to receive and support at least a portion of an entire length of respective opposing side surfaces defining each connector body. When a lateral force is applied to the connector body, the frame assembly acts as a support and transfers the lateral force to the PCB, thereby reducing a rotational moment at a base of each connector body connected to the PCB.

IBM® is a registered trademark of International Business Machines Corporation, Armonk, New York, U.S.A. Other names used herein may be registered trademarks, trademarks or product names of International Business Machines Corporation or other companies.

### BACKGROUND OF THE INVENTION

1. Field of the Invention

This invention relates to a method and apparatus for restricting a rotational moment about a longitudinal axis of surface-mount (SMT) connectors, and particularly to a method and apparatus for restricting the rotational moment about the longitudinal axis of SMT DIMM Sockets and other SMT connectors.

2. Description of Background

In computer systems such as personal computers, a socket is referred to as an electrical connector generally mounted on a motherboard (main board) in order to connect extension boards such as extended interface boards for peripheral devices or extended memory boards to the motherboard. The motherboard and extension boards can be electrically connected by plugging the extension boards into the electrical connector.

The structure of a common electrical connector will be described here with the example of an electrical connector used to connect an extension memory module (hereinafter, “module”) referred to as a DIMM (dual in-line memory module) as illustrated in FIGS. 1 and 2. This module corresponds to the extension board described above.

A dual in-line memory module (DIMM) is more and more popular for use in the present PC industry, and thus uses a DIMM socket connector mounted on the motherboard for mechanical and electrical interconnect of the corresponding DIMM therein for signal transmission between the motherboard and the DIMM. A main feature of the typical DIMM connector as illustrated in FIGS. 1 and 2 is that the DIMM connector 10 includes generally a pair of latch/eject members 12 at its two opposite ends so that such DIMM may not only be properly retained in the DIMM connector 10 without possibility of inadvertent withdrawal by vibration or external impact, but also easily ejected from the DIMM connector 10 by rotational movement of the latch/eject member 12.

With more of the industry moving to SMT (Surface Mount Technology) connectors due to PCB wiring density, path length, and electrical signal integrity concerns, new mechanical requirements emerge due to the delicate SMT interface, compared to the more mechanically robust compliant pin and pin-through-hole interfaces in previous applications. This disclosure addresses the forces and strains incurred at the SMT solder joint and pad interface due to rotation about the long axis of an SMT DIMM socket or housing 14, for example, as well as the possibility of pad delamination at the card surface, by minimizing the overall rotation about the longitudinal axis of the SMT DIMM socket, as illustrated in FIG. 2.

Rotation about the longitudinal axis of the SMT DIMM socket 14 is caused by a number of factors. One factor is the amount and location of the center of mass of the DIMM module (not shown). The module acts as a cantilevered beam when assembled into the socket 10, where shock, vibration, and dead load effects can all contribute to moments being applied to the DIMM connector 10, particularly when the DIMM module is plugged parallel to the ground and perpendicular to a motherboard 16 on which the DIMM connector 10 is surface mounted thereto. Another factor is due to the design of the connector 10 itself, allowing rotation of the DIMM module upon insertion. The traditional DIMM socket allows approximately 10 degrees of rotation centered about a perpendicular plane to a printed circuit board (PCB) surface defined by the motherboard 16. This allowable rotation, coupled with the high insertion forces required to mate the interface between the DIMM module and the socket, results in a high lateral load forming a torsional moment about the longitudinal axis of the connector inducing an undesirable shear stress to the SMT joint and PCB pad, regardless of orientation of the module and connector with respect to gravity. This stress to the SMT joints, as well as the SMT pad, creates a reliability concern, and the possibility of pad delamination.

Previous designs were mechanically anchored to the PCB via the pin-through-hole or compliant pin nature of the PCB leads, as discussed above which provided a larger reaction force to the lateral shear and torsional moments than the present SMT joints provide. With the present surface-mount design, the reaction forces are carried through the SMT joints and PWB solder pads, which are not as robust as pin-in-hole connections to withstand such forces, and pose a reliability concern.

### SUMMARY OF THE INVENTION

The shortcomings of the prior art are overcome and additional advantages are provided through the provision of an apparatus for supporting at least one electrical connector body. The apparatus includes a mechanical frame assembly mountable to a printed circuit board (PCB) and separable from the at least one connector body and the PCB. The frame assembly includes at least one base member for attachment to the PCB; and a plurality of rigid body members each spaced apart from one another and extending from the at least one base member or an adjacent rigid body member. A rigid member attached to an entire length or respective opposing sides of a connector housing provides restraint to shear stresses induced due to rotational moment. When a lateral force is applied to the connector body, the frame assembly acts as a support and transfers the lateral force to the PCB, thereby reducing a rotational moment at a base of each connector body connected to the PCB.

In another exemplary embodiment, a system includes: a motherboard; a plurality of electrical connectors surface mounted to the motherboard, each electrical connector including a connector body configured to receive and electrically connect an electrical module; and a mechanical frame assembly mountable to the motherboard and separable from the electrical connectors and the motherboard. The frame assembly includes at least one base member for attachment to the motherboard; and a plurality of rigid body members each spaced apart from one another and extending from at least one base member or an adjacent rigid body member. The plurality of rigid body members receive a grouping of one or more connector bodies and a pair of adjacent rigid body members are configured to receive and support at least a portion of an entire length of respective opposing side surfaces defining each connector body. When a lateral force is applied to the connector body, the frame assembly acts as a support and transfers the lateral force to the motherboard, thereby reducing a rotational moment at a base of each connector body connected to the motherboard.

In still another exemplary embodiment, a method of constraining rotation of at least one electrical connector about a longitudinal axis thereof at an interface of a motherboard to winch it is surface mounted is disclosed. The method includes: configuring a connector body of each electrical connector to receive and electrically connect an electrical module; and mounting a mechanical frame assembly to the motherboard before or during mounting of the electrical connectors, the frame assembly being separable from the electrical connectors and the motherboard. The frame assembly includes at least one base member for attachment to the motherboard; and a plurality of rigid body members each spaced apart from one another and extending from the at least one base member or an adjacent rigid body member. The plurality of rigid body members receive a grouping of one or more connector bodies and a pair of adjacent rigid body members are configured to receive and support at least a portion of an entire length of respective opposing side surfaces defining each connector body. When a lateral force is applied to the connector body, the frame assembly acts as a support and transfers the lateral force to the motherboard, thereby reducing a rotational moment at a base of each connector body connected to the motherboard.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a perspective view of a conventional DIMM connector;

FIG. 2 illustrates an elevation end view of the DIMM connector of FIG. 1 surface mounted to a PCB surface of a motherboard (show module 14);

FIG. 3 illustrates an elevation end view of the DIMM connector of FIG. 1 surface mounted to a PCB surface of a motherboard with all exemplary embodiment of a lateral constraint member of a frame assembly disposed on either side of the DIMM connector;

FIG. 4 illustrates a partial elevation end view of two of the DIMM connectors of FIG. 4 having a rigid member of a frame assembly therebetween in accordance with an exemplary embodiment of the present invention;

FIG. 5 illustrates a top plan view of DIMM connectors surface mounted to the PCB surface of the motherboard showing various exemplary embodiments of configurations of lateral constraint member frame assemblies in accordance with exemplary embodiments of the present invention;

FIG. 6 illustrates a top plan view of an exemplary embodiment of lateral constraints at end portions between two DIMM connectors (case 1) and four DIMM connectors (case 2); and

FIG. 7 illustrates a table of results of finite element modeling for cases 1 and 2 of FIG. 6 showing that constraining the rotation of the DIMM connectors via rigid-body members contacting/joining the DIMM connector housings greatly decreases the allowable rotation of the connector and thus the rotational moment and shear stress of the SMT joints and PCB pads.

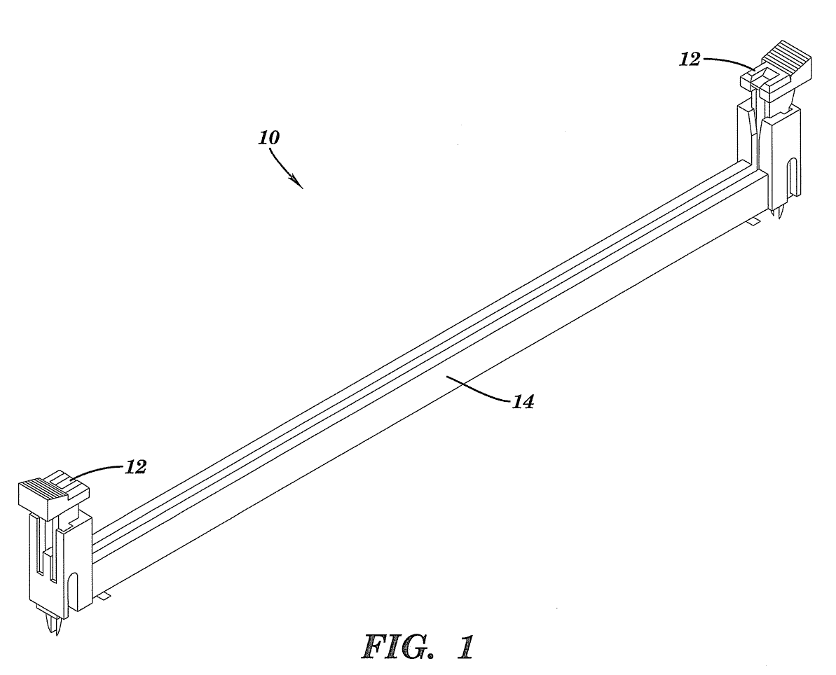

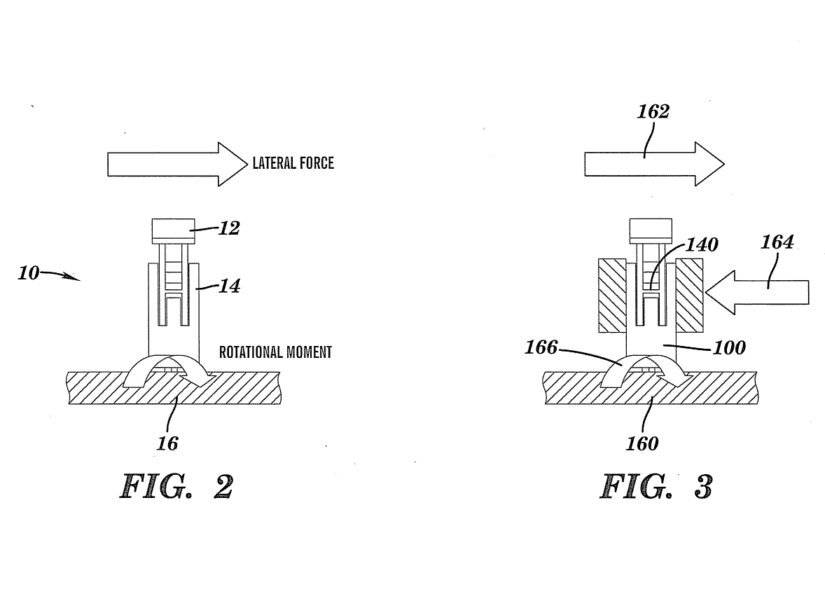

The detailed description explains the preferred embodiments of the invention, together with advantages and features, by way of example with reference to the drawings.

### DETAILED DESCRIPTION OF THE INVENTION

Turning now to the drawings in greater detail, the structure of a common electrical connector will be described here with the example of an electrical connector used to connect an extension memory module (hereinafter, “module”) referred to as a DIMM (dual in-line memory module). This module corresponds to the extension board described above.

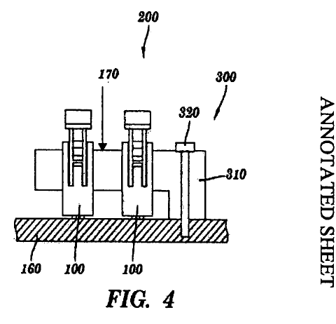

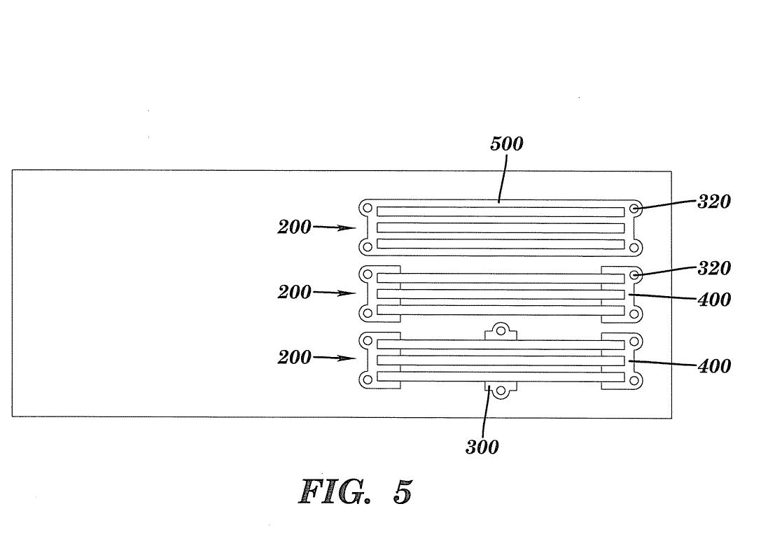

FIG. 3 is schematic elevation end view illustrating the structure of an electrical connector assembly 100 for a DIMM (not shown) according to the present invention. The electrical connector assembly 100 is an electrical connector which is used in desktop personal computers, for example. In FIG. 3, the connector assembly 100 is defined by a housing 140 for housing a respective module (not shown). The modules are arranged in several rows (e.g., three rows in FIG. 5) on a PCB or motherboard 160. The user inserts a module (not shown) in the housing 140, allowing memory to be added on. When the housing 140 is arranged standing up on the motherboard 160, as illustrated in FIG. 3, the module is held perpendicular to the motherboard 160. In order to counteract a lateral force indicated with arrow 162 when inserting a module (not shown) for electrical connection with the connector assembly 100, a reaction force indicated with arrow 164 may be applied to preserve the integrity of the SMT joint interface between the connector assembly 100 and the motherboard 160. The reaction force 164 is applied by exemplary lateral constraint members or rigid body members 170 of an exemplary embodiment of a frame assembly 300 (as best shown in FIG. 4) disposed on either side of each connector assembly 100. The reaction force 164 reduces a rotational moment 166 about a longitudinal axis defined by the connector 100 assembly at the SMT joint interface between the connector 100 assembly and the motherboard 160 when the lateral force 162 is applied.

Still referring to FIG. 3, it will be recognized by those skilled in the art that in the force diagram thereof, the opposite (reverse) would be true as well, as adjacent spaced apart rigid body members 170 contact both sides of the DIMM connector assembly 100. The force depicted in FIG. 3 would be induced by either a non-perpendicular plugging (which is allowed in the connector design), or by gravitational force if the overall assembly was rotated 90 degrees, as is typical in system applications.

The rigid body members 170 acting as interstitial braces can be applied to the connector assembly 100 in various ways, as described hereinbelow. In an exemplary embodiment as illustrated in FIG. 4, the rigid body members 170 are defined by lateral constraint members extending from a base member 310 of the frame assembly 300. The base member 310 is fixed to the motherboard 160 via a fixing member 320 extending through the base member 310 and fixed to the motherboard 160. The fixing member 320 may be a pin, screw, rivet, or any mechanical fastener that is known or will later become known. It is also contemplated that the base member 310 may be affixed to the motherboard 160 using an adhesive that is known or will later become known. The frame assembly 300 having the lateral restraint members 170 may be include one, two or three frame assemblies 300 to form compound connector assemblies, as illustrated in FIG. 5.

Referring to FIG. 5, the ganging of connector assemblies 100 provides an assembly 200 of a given number of connector assemblies 100 as one rigid entity and provides a more stable geometry and minimizes the rotation of any one connector assembly 100 in the ganged assembly 200. The frame assembly 300 is not limited to the configuration of FIG. 4 illustrating a location thereof at an intermediate portion between opposing ends defining the ganged assembly 200, but can be also configured as frame assemblies 400 for placement at respective ends of the ganged assembly 200 as illustrated in the two lower ganged assemblies illustrated in FIG. 5. In an alternative exemplary embodiment, a single frame assembly 500 may be configured to surround an entire length, including ends of each connector assembly 100, as illustrated in the upper ganged assembly illustrated in FIG. 5. Accordingly, frame assemblies 300, 400 and 500 may be selected based on the desired placement of lateral constraint members at multiple locations along a body defining each connector assembly 100, as determined by the amount of reaction force 164 required to counteract the lateral force 162 (FIG. 3). Thus, the lateral restraint members 170 of a selected frame assembly may have various configurations and may be disposed along an entire length and ends, at ends, or at ends and midpoints of a connector assembly 100.

The lateral restraint members 170 of a frame assembly 300, 400, or 500 may also be designed such that they do not run the entire height of the connector, as illustrated in FIGS. 3 and 4, such that a volume is allowed for component placement below the lateral restraint members 170 on PCB 160. Although it is desirable, it not necessary, to leave a volume beneath the lateral restraint members 170 to allow for component placement or increased air flow between PCB 160 and a bottom surface defining the lateral restraint members 170 of a frame assembly 300, 400, or 500.

The geometry of the lateral restraint members 170 is not specific, as they can be designed for ease of disassembly/rework of the individual connector assemblies 100 in the ganged assembly 200, or other factors specific to the given application. One advantage to having the lateral restraint members 170 configured to allow translation past opposing and adjacent lateral restraint members 170 engages with a connector body of one connector assembly is that it allows for vertical removal of the DIMM connector assemblies 100 in rework. In other words, it is preferable that the lateral restraint members 170 do not engage a shoulder or horizontal portion of a connector assembly 100 so as to prevent removal in order to allow for potential removal of the connector assembly 100 from a ganged assembly 200. The reworkability of this design is an advantage over one large connector assembly with multiple slots resembling the ganged assembly 200. Instead of pulling off an entire large connector assembly with multiple slots in rework, an individual isolated connector assembly 100 can be removed without disturbing the adjacent connector assemblies 100 of a ganged assembly 200.

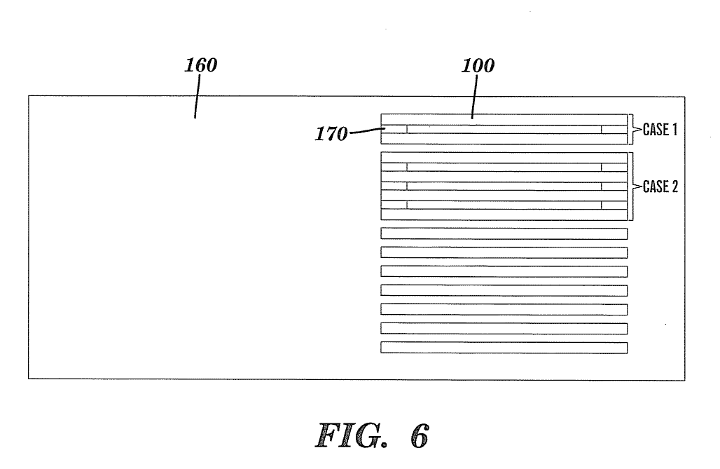

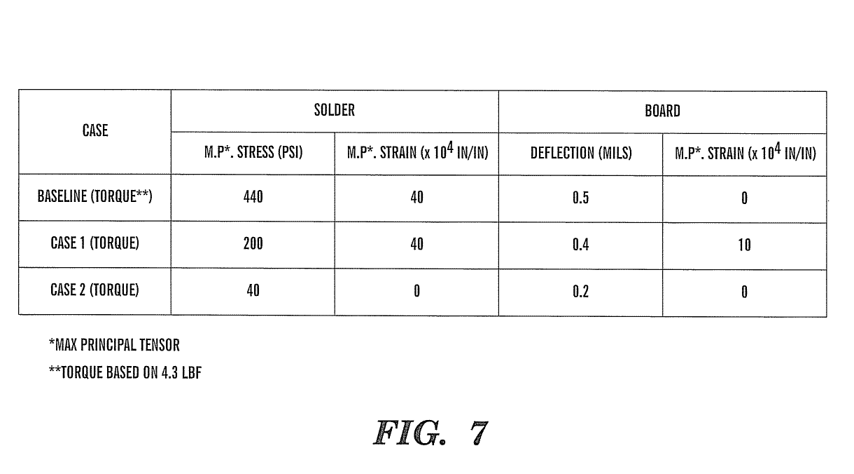

Referring to FIGS. 6 and 7, it has been proven via finite element modeling that constraining the rotation of the DIMM connector assemblies 100 via rigid-body members (e.g., interstitial braces 170) contacting/joining the housings thereof greatly decreases the allowable rotation of the connector assembly 100 and thus the rotational moment and shear stress of the SMT joints and PCB pads. Material properties, dimensions, and tolerances of the body/housing interface are application dependent.

Case 1 of FIGS. 6 and 7 illustrates a situation where interstitial braces or rigid body members 170 are disposed at ends and between alternate pairs of DIMM connector assemblies 100, having a 7 mm length. Case 2 of FIGS. 6 and 7 illustrates a situation where interstitial braces or rigid body members 170 are disposed between a group of four DIMM connector assemblies 100 and at ends thereof. The DIMM collector assemblies 100 were 3, 4, 5, 6 and 7 mm in length and using anisotropic material data sets for all materials in the finite element model. In both cases 1 and 2, the allowable pad stress is 44-65 psi.

From the above described exemplary embodiments, the following attributes of the present invention are disclosed. In instances where a user wants to utilize traditionally-styled connectors, including DIMM connectors, a frame is proposed. In particular, a mechanical frame assembly separate from the connector body, which can be attached to the card and constrain DIMM connectors of traditional geometry is proposed. The frame assembly can contact the connectors at the ends, at the ends and at points along the connector body, or throughout the length of the connector body. Further, the frame can be designed to allow for component placement on the card under the frame assembly, by limiting the number of lands and attach points to the card. In exemplary embodiments as described above, a mechanical frame assembly, separate from the connector body, hugs a grouping of one or more connectors. If a lateral force is applied to the connector (e.g., a DIMM is inserted at an angle) the mechanical frame assembly acts as a support and transfers the lateral force to the board/card enclosure (e.g., a motherboard). It is preferred, but not necessary, to leave a volume beneath the mechanical assembly to allow for component placement or increased air flow. The mechanical frame assembly can be installed onto the motherboard before the connectors are installed, or the mechanical frame can be installed at the same time as the connectors are installed.

While the preferred embodiments to the invention has been described, it will be understood that those skilled in the art, both now and in the future, may make various improvements and enhancements which fall within the scope of the claims which follow. These claims should be construed to maintain the proper protection for the invention first described.

1. An apparatus for supporting at least one electrical connector body having opposing long surfaces and opposing short surfaces at respective ends of the long surfaces, the apparatus comprising:
a mechanical frame assembly mountable to a printed circuit board (PCB) and separable from the at least one connector body and the PCB, the frame assembly including;
at least one base member for attachment to the PCB; and
a plurality of rigid body members each spaced apart from one another and extending from the at least one base member or an adjacent rigid body member, the plurality of rigid body members receive a grouping of one or more connector bodies such that each rigid body member of a pair of adjacent rigid body members abuts at least a portion of a corresponding long surface of the corresponding connector body,
wherein when a lateral force is applied to the connector body, the frame assembly acts as a support and transfers the lateral force to the PCB, thereby reducing a rotational moment at a base of each connector body connected to the PCB.

2. The apparatus of claim 1, wherein each rigid body member and base member is integral to the frame assembly.

3. The apparatus of claim 1, wherein the rigid body members are aligned with multiple locations along the length defining the connector body.

4. The apparatus of claim 1, wherein each connector body is a DIMM connector body.

5. The apparatus of claim 1, wherein the rigid body members are aligned with one another.

6. The apparatus of claim 5, wherein the frame assembly facilitates vertical removal of at least one of the connector bodies.

7. The apparatus of claim 1, wherein the plurality of rigid body members are configured such that an air volume is formed between the rigid body members and the PCB.

8. A system comprising:
a motherboard;
a plurality of electrical connectors surface mounted to the motherboard, each electrical connector including a connector body, having opposing long surfaces and opposing short surfaces at respective ends of the long surfaces, configured to receive and electrically connect an electrical module; and
a mechanical frame assembly mountable to the motherboard and separable from the electrical connectors and the motherboard, the frame assembly including;
at least one base member for attachment to the motherboard; and
a plurality of rigid body members each spaced apart from one another and extending from the at least one base member or an adjacent rigid body member, the plurality of rigid body members receive a grouping of one or more connector bodies such that each rigid body member of a pair of adjacent rigid body members abuts at least a portion of a corresponding long surface of the corresponding connector body,
wherein when a lateral force is applied to the rigid connector body, the frame assembly acts as a support and transfers the lateral force to the motherboard, thereby reducing a rotational moment at a base of each connector body connected to the motherboard.

9. The system of claim 8, wherein each rigid body member and base member are integral to the frame assembly.

10. The system of claim 8, wherein the rigid body members are aligned with multiple locations along the length defining the connector body.

11. The system of claim 8, wherein each connector body is a DIMM connector body.

12. The system of claim 8, wherein the rigid body members are aligned with one another.

13. The system of claim 12, wherein the frame assembly facilitates vertical removal of at least one of the connector bodies.

14. The system of claim 8, wherein the plurality of rigid body members are configured such that an air volume is formed between the rigid body members and the PCB.

15. A method of constraining rotation of at least one electrical connector about a longitudinal axis thereof at an interface of a motherboard to which it is surface mounted, the method comprising:
configuring a connector body, having opposing long surfaces and opposing short surfaces at respective ends of the long surfaces, of each electrical connector to receive and electrically connect to an electrical module; and
mounting a mechanical frame assembly to the motherboard before or during mounting of the electrical connectors, the frame assembly being separable from the electrical connectors and the motherboard, the frame assembly including;
at least one base member for attachment to the motherboard; and
a plurality of rigid body members each spaced apart from one another and extending from the at least one base member or an adjacent rigid body member, the plurality of rigid body members receive a grouping of one or more connector bodies such that each rigid body member of a pair of adjacent rigid body members abuts at least a portion of a corresponding long surface of the corresponding connector body,
wherein when a lateral force is applied to the connector body, the frame assembly acts as a support and transfers the lateral force to the motherboard, thereby reducing a rotational moment at a base of each connector body connected to the motherboard.

16. The method of claim 15, further comprising configuring each rigid body member and base member integral to the frame assembly.

17. The method of claim 15, further comprising locating the rigid body members to be aligned with multiple locations along the length defining the connector body.

18. The method of claim 15, wherein each connector body is a dual in-line memory module (DIMM) connector body configured to receive a DIMM.

19. The method of claim 15, wherein the rigid body members are aligned with one another.

20. The method of claim 15, further comprising configuring the plurality of rigid body members such that an air volume is formed between the rigid body members and the motherboard.
